(19) United States
(12) Patent Application Publication
(10) Pub. No.: US 2026/0003581 A1
(43) Pub. Date: Jan. 1, 2026

(54) WORKFLOW CREATION

(71) Applicant: Beijing Zitiao Network Technology Co., Ltd., Beijing (CN)

(72) Inventor: Xuneng Huang, Beijing (CN)

(21) Appl. No.: 18/891,705

(22) Filed: Sep. 20, 2024

(30) Foreign Application Priority Data
Jun. 30, 2024 (CN) 202410870549X

(51) Int. Cl. G06Q 10/0633

(52) U.S. Cl. CPC G06F 8/34

(57) ABSTRACT

Embodiments of the disclosure relate to a method, apparatus, device, and storage medium for workflow creation. The provided method includes: in response to a received operation, adding a first node associated with a question-and-answer interaction to a node connected graph; obtaining configuration information for the first node via a set of input controls associated with the first node, the configuration information indicating: a target question to be provided in response to the first node being triggered, and a target action to be executed by the first node based on a response received for the target question; and creating a target workflow based on the node connected graph. In this way, the embodiments of the disclosure can support adding a question-and-answer node so as to obtain a response content for a particular question from users and trigger an action to be executed during execution of the workflow.

### CROSS-REFERENCE

The present application claims priority to Chinese Patent Application No. 202410870549X, filed on Jun. 30, 2024, and entitled “WORKFLOW CREATION METHOD, APPARATUS, DEVICE AND STORAGE MEDIUM”, the entirety of which is incorporated herein by reference.

### FIELD

Example embodiments of the present disclosure generally relate to the field of computers, and more particularly, to workflow creation.

### BACKGROUND

With the development of computer technologies, people can create various types of applications on some platforms. In the process of developing applications, it is an important task to create and manage workflows. For example, a user may edit a node in a workflow to indicate a process flow for a request.

### SUMMARY

In a first aspect of the present disclosure, a method of workflow creation is provided. The method includes: in response to a received operation, adding a first node associated with a question-and-answer interaction to a node connected graph; obtaining configuration information for the first node via a set of input controls associated with the first node, the configuration information indicating: a target question to be provided in response to the first node being triggered, and a target action to be executed by the first node based on a response received for the target question; and creating a target workflow based on the node connected graph.

In a second aspect of the present disclosure, an apparatus for workflow creation is provided. The apparatus includes: an adding module configured to add, in response to a received operation, a first node associated with a question-and-answer interaction to a node connected graph; an obtaining module configured to obtain configuration information for the first node via a set of input controls associated with the first node, the configuration information indicating: a target question to be provided in response to the first node being triggered, and a target action to be executed by the first node based on a response received for the target question; and a creating module configured to create a target workflow based on the node connected graph.

In a third aspect of the present disclosure, an electronic device is provided. The device includes at least one processing unit; and at least one memory, the at least one memory being coupled to the at least one processing unit and storing instructions for execution by the at least one processing unit. The instructions, when executed by the at least one processing unit, cause the device to perform operations that implement the method of the first aspect.

In a fourth aspect of the present disclosure, a computer readable storage medium there is provided. The computer readable storage medium stores a computer program, and the computer program is executable by a processor to perform operations that implement the method of the first aspect.

It would be appreciated that what is described in this Summary section is not intended to limit critical features or essential features of embodiments of the present disclosure, nor is it intended to limit the scope of the present disclosure. Other features of the present disclosure will become readily appreciated from the following description.

### BRIEF DESCRIPTION OF THE DRAWINGS

The above and other features, advantages, and aspects of various embodiments of the present disclosure will become more apparent with reference to the following detailed description taken in conjunction with the accompanying drawings. In the drawings, the same or similar reference numerals denote the same or similar elements, wherein:

FIG. 1 illustrates a schematic diagram of an example environment.

FIG. 2 illustrates a flowchart of an example process for workflow creation.

FIG. 3A illustrates an example editing interface.

FIG. 3B illustrates an example interaction interface.

FIG. 3C illustrates an example question-and-answer node.

FIG. 3D illustrates an example interaction interface.

FIG. 4 illustrates a schematic structural block diagram of an example apparatus for workflow creation.

FIG. 5 illustrates a block diagram of an example electronic device in which various embodiments of the present disclosure may be implemented.

### DETAILED DESCRIPTION

The embodiments of the present disclosure will be described in more detail below with reference to the accompanying drawings. Although certain embodiments of the present disclosure are shown in the drawings, it would be appreciated that the present disclosure can be implemented in various forms and should not be interpreted as limited to the embodiments described herein. On the contrary, these embodiments are provided for a more thorough and complete understanding of the present disclosure. It would be appreciated that the accompanying drawings and embodiments of the present disclosure are only for the purpose of illustration and are not intended to limit the scope of protection of the present disclosure.

It should be noted that the headline of any section/subsection provided in the specification is not limiting. Various embodiments are described throughout the specification and any type of embodiments may be included in any section/subsection. Furthermore, the embodiments described in any section/subsection may be combined in any manner with any other embodiment described in the same section/subsection and/or different sections/subsections.

In the description of the embodiments of the present disclosure, the term “including” and similar terms would be appreciated as open inclusion, that is, “including but not limited to”. The term “based on” would be appreciated as “at least partially based on”. The term “one embodiment” or “the embodiment” would be appreciated as “at least one embodiment”. The term “some embodiments” would be appreciated as “at least some embodiments”. Other explicit and implicit definitions may also be included below.

The embodiments of the present disclosure may relate to user data, acquisition and/or use of data, and the like. These aspects shall comply with the requirements of corresponding laws, regulations and relevant provisions. In the embodiments of the present disclosure, the collection, acquisition, processing, manufacturing, forwarding, use of all data and the like are carried out with the user's knowledge and consent. Accordingly, in the implementation of the embodiments of the present disclosure, users should be informed of the type, the scope of use, the use scenario, etc., of the involved data or information in an appropriate manner and provide authorization in accordance with relevant laws and regulations. The specific ways of being informed and providing authorization may vary according to actual circumstances and application scenarios, and the scope of this disclosure is not limited in this regard.

In the solutions and embodiments in this disclosure, if personal information processing is involved, it will be carried out based on legitimate grounds (such as obtaining consent from the data subject, or as required to fulfill a contract”, etc.) and will be processed only within the specified or agreed scope. If users decline the processing of personal information beyond what is essential for basic functionalities, their utilization of these basic features remains uninterrupted.

Traditionally, users can quickly create workflows by, for example, configuring various processing nodes in a workflow. However, during execution of the workflow, the workflow is usually executed according to a configured preset logic and it is difficult for the users to control the execution logic of the workflow during the execution.

The embodiments of the present disclosure provide solutions for workflow creation. According to one solution, a first node associated with a question-and-answer interaction is added to a node connected graph in response to a received editing operation. Configuration information for a first node is obtained via a set of input controls associated with the first node, and the configuration information indicates: a target question to be provided in response to the first node being triggered, and a target action required to be executed by the first node based on a response content of the target question. A target workflow is created based on the node connected graph.

In this way, the embodiments of the present disclosure can support the addition of a question-and-answer node so as to obtain a response content for a particular question from users and trigger an action to be executed during execution of the workflow.

Various example implementations of the solution are described in further detail below with reference to the accompanying drawings.

### Example Environment

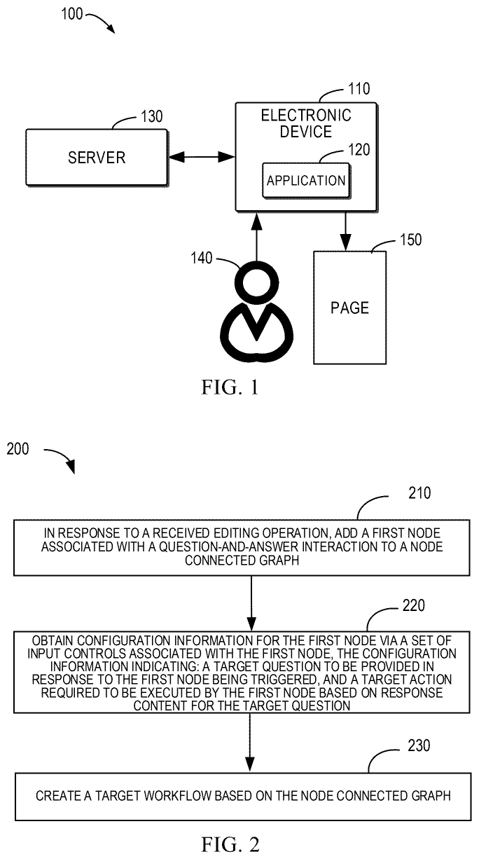

FIG. 1 shows a schematic diagram of an example environment 100 in which embodiments of the present disclosure can be implemented. As shown in FIG. 1, the example environment 100 may include an electronic device 110.

In this example environment 100, the electronic device 110 may run an application 120 that supports interface interaction. The application 120 can be any suitable type of application for interface interaction, examples of which may include, but are not limited to, a development application or other suitable application that supports workflow creation. A user 140 may interact with the application 120 via the electronic device 110 and/or its attached device.

In the environment 100 of FIG. 1, if the application 120 is active, the electronic device 110 may present a page 150 via the application 120 for supporting workflow creation.

In some embodiments, the electronic device 110 communicates with a server 130 to enable provisioning of services to the application 120. The electronic device 110 may be any suitable type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 can also support any type of interface for a user (such as a “wearable” circuit, etc.).

The server 130 may be a standalone physical server, a server cluster composed of multiple physical servers, or a distributed system, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, or the like. The server 130 may provide background services for the application 120 that support virtual scenes in the electronic device 110.

A communication connection may be established between the server 130 and the electronic device 110. The communication connection may be established in a wired manner or a wireless manner. The communication connection may include, but is not limited to, a Bluetooth connection, a mobile network connection, a Universal Serial Bus (USB) connection, a Wireless Fidelity (WiFi) connection, and the like, and the embodiments of the present disclosure are not limited in this aspect. In the embodiments of the present disclosure, the server 130 and the electronic device 110 may implement signaling interaction through a communication connection between the server 130 and the electronic device 110.

It would be appreciated that the structures and functions of the various elements in the environment 100 are described for example purposes only and do not imply any limitation to the scope of the present disclosure.

Some example embodiments of the present disclosure will be described below with continued reference to the accompanying drawings.

### Example Processes

FIG. 2 illustrates a flowchart of a process 200 for workflow creation according to some embodiments of the present disclosure. In the context of the present disclosure, the “workflow creation” may include various forms of workflow creation. For example, the example process 200 may be used to create a new workflow, or an editing interface as described below may be used to open and edit an existing workflow. The process 200 may be implemented at the electronic device 110. The process 200 is described below with reference to FIG. 1.

As shown in FIG. 2, at block 210, in response to a received editing operation, the electronic device 110 adds a first node associated with a question-and-answer interaction to a node connected graph.

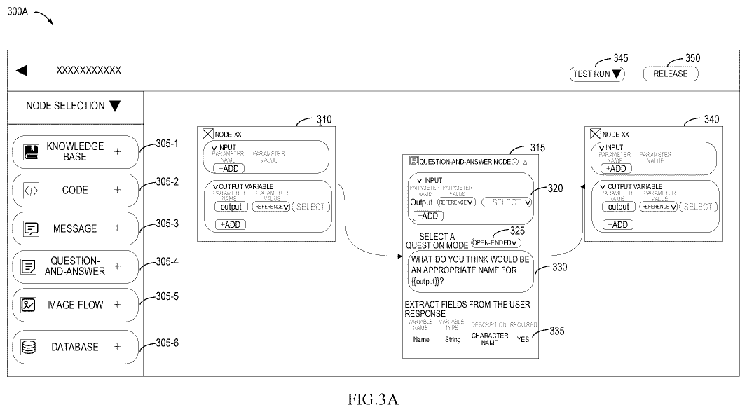

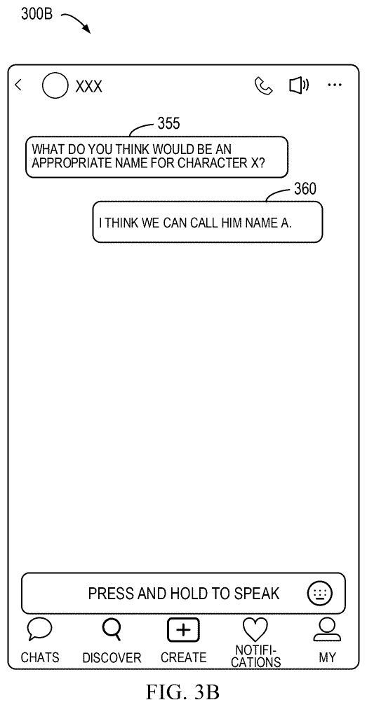

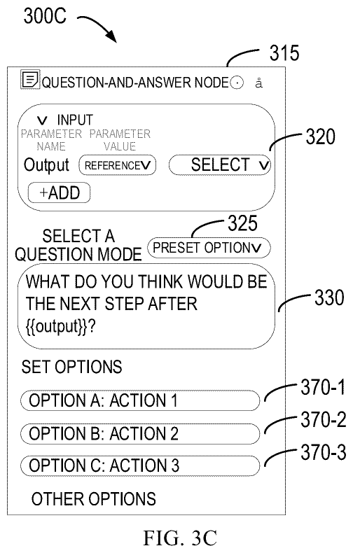

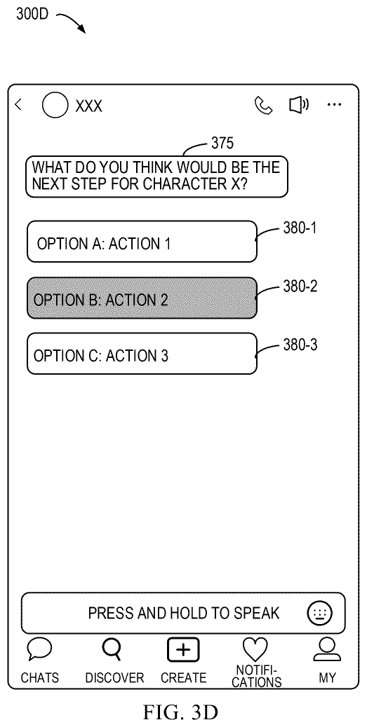

The process 200 will be described below with reference to FIG. 3A. FIG. 3A illustrates an example editing interface 300A in accordance with some embodiments of the present disclosure.

As shown in FIG. 3A, the interface 300A can be a node editing interface for workflow creation. As shown, the electronic device 110 may present, in the interface 300A, a plurality of interface elements that correspond to a plurality of node types, e. g., an interface element 305-1 through an interface element 305-6. As an example, the interface element 305-1 may be configured to add a knowledge base node, the interface element 305-2 may be configured to add a code node, the interface element 305-3 may be configured to add a message node, the interface element 305-4 may be configured to add a question-and-answer node, the interface element 305-5 may be configured to add an image flow node, and the interface element 305-6 may be configured to add a database node.

In some embodiments, the embodiments of the present disclosure may support the addition of other suitable types of nodes, in addition to the specific nodes above. For example, the electronic device 110 can support the user adding another workflow that has been created as a single processing node into the node connected graph.

As an example, the electronic device 110 may receive a user selection of the interface element 305-4 to add a first node 315 to the node connected graph. The first node 315 is also referred to as a question-and-answer node and configured for triggering a question-and-answer interaction during execution.

At block 220, the electronic device 110 obtains configuration information for a first node via a set of input controls associated with the first node, the configuration information indicating: a target question to be provided in response to the first node being triggered, and a target action required to be executed by the first node based on a response content for the target question.

As shown in FIG. 3A, the electronic device 110 may present an editing window for the first node 315 and may provide one or more input controls in the editing window for editing the configuration information for the first node 315.

In some embodiments, the electronic device 110 may connect the first node 315 to a second node 310 in the node connected graph, e.g., based on a user's editing operation, to indicate that the first node 315 may be triggered after the second node 310. In some embodiments, the second node 310 may include any suitable type of node described above.

In some examples, the first node 315 may be triggered to be executed after execution of one or more preceding nodes (e.g., the second node 310) in the node connected graph that are directly connected to the first node 315.

Additionally, the electronic device 110 may provide an input control 320 for configuring an input parameter of the first node 315. In some embodiments, the electronic device 110 can allow a user to define an input parameter by referencing a data object defined in a further associated node (e. g., the second node 310). As another example, the electronic device 110 may also support creating a new parameter in the first node 315, for instance.

Taking FIG. 3A as an example, the electronic device 110 may configure the input parameter “output” through the control 320, for example, which may be performed by referencing an output parameter of the second node 310.

Additionally, the electronic device 110 may provide an input control 325 for configuring a question type corresponding to the first node 315. In some embodiments, the input control 325 may, for example, provide two candidate question types. As shown in FIG. 3A, a first question type may, for example, be referred to as an open-ended question, which indicates that the user can use a free input to answer the proposed question.

Further, the electronic device 110 may use an input control 330 to obtain question description text, e.g., “What do you think would be an appropriate name for {{output}}?”. Further, the first node 315 may determine, based on the question description text, the question to be presented to the user in response to the first node 315 being triggered for execution.

In some embodiments, the question description text may include, for example, a reference to an input parameter, e.g., “{{output}}”. Further, as introduced above, the input parameter references the data object from the associated second node 310. In some embodiments, the question description text may also include, for example, a reference to a new parameter declared at the first node 315. It should be appreciated that such an associated node may include any suitable preceding node of the first node 315 in the node connected graph, and the associated node is not required to be directly connected with the first node 315.

Additionally, when the input control 325 indicates that the first node 315 corresponds to the first question type (i.e., an open-ended question), the electronic device 110 may also obtain parameter description information via an input control 335. The parameter description information may, for example, be configured to indicate at least one parameter (or field) to be determined based on the user's response content to the proposed question.

Taking FIG. 3A as an example, the electronic device 110 may determine, e.g., by using the input control 335, that a name of the parameter to be extracted is “Name”, a type of the parameter to be extracted is a string type, and the parameter is configured to describe a character name. In some examples, the parameter may be, for example, a field that must be extracted.

In some embodiments, the first node 315 may be configured to process the response content using any suitable model to extract values of parameters from the response content in accordance with the parameter description information.

In some embodiments, during execution of the target application, if the first node 315 fails to extract any value of the parameter from the user's response content 335, the first node 315 may, for example, trigger the target application to perform one or more rounds of follow-up questions to the user. In some embodiments, the follow-up questions may be the same as the target question configured by the first node, or the follow-up questions may be questions regenerated based on the user's response content.

In some embodiments, the first node 315 may further configure the maximum number of the allowable rounds. As an example, if the first node 315 still fails to extract any value of the parameter after a predetermined number of rounds of follow-up questions, the target application, for example, ends the execution of the first node 315.

As shown in FIG. 3B, when the workflow including the first node 315 is triggered to be executed, the first node 315 may trigger provision of a target question 355. The target question may be determined based on the question description text described above.

For example, the second node 310 may determine, during the execution, that the value of the variable “output” is “Character X”. Accordingly, the content of the target question 355 may be “What do you think would be an appropriate name for Character X”.

Further, the first node 315 may obtain a response content 360 that is input by the user. The response content 360 may include, for example, an appropriate content input by the user through the input control, such as text content, voice content, expression content, video content, and image content.

Further, the first node 315 may process the response content 360 using a language model to extract a parameter matching the parameter description information. For example, the first node 315 may utilize the language model to determine that the parameter value of the parameter “Name” is “Name A” based on the response content 360.

In this case, the target action that is required to be executed by the first node 315 based on the response content for the target question may include determining a value of one or more configured parameters from the response content.

With continued reference to FIG. 3A, the node connected graph, for example, may further include a third node 340 connected to the first node 315. The third node 340 may, for example, support referencing a parameter, e.g., “Name”, extracted by the first node 315.

Accordingly, during the execution of the workflow, a parameter value (e.g., “Name A”) of the parameter “Name” that is determined based on the response content 360 may be provided to the third node 340 for further processing by the subsequent node in the workflow.

In some embodiments, as shown in FIG. 3C, the first node 315 may be configured to be associated with a second question type (also referred to as a question with preset options), for example, through the input control 325. Similarly, the electronic device 110 may obtain the question description text by using the input control 330.

Unlike the example of FIG. 3A, as shown in FIG. 3C, for a question with preset options, the electronic device 110 may configure a set of candidate answers to the target question through, for example, an input control 370-1, an input control 370-2, and an input control 370-3. Similar to the question description text, the set of candidate answers may be described, for example, by referencing a data object in an associated node (e.g., the second node 310).

As shown in FIG. 3D, when the first node 315 is triggered to be executed, a target question 375 determined based on the question description text may be provided to the user. Further, three candidate answers 380-1, 380-2, and 380-3 configured based on the input controls 370-1 through 370-3 may also be provided.

As an example, the user may select the candidate answer 380-2 as the response content to the target question 375. As another example, the user may input a response message (such as a text message, a voice message, or the like) to the target question 375, for example, by the input control.

Further, the first node 315 may process the response message by using a language model to determine whether it matches the provided candidate answers 380-1, 380-2, and 380-3. For example, if the response content input by the user is “OPTION B”, the first node 315 may determine that the response content indicates candidate answer 380-2.

As another example, upon determining that the response message does not match any of the candidate answers 380-1, 380-2, and 380-3, the first node 315 may determine that the response content corresponds to a further option. In some examples, as shown in FIG. 3C, the electronic device 110 may further receive a configuration operation that indicates actions corresponding to various candidate answers or the further option. For example, the electronic device 110 may add a corresponding fourth node following a corresponding input control to indicate an action triggered to be executed when the candidate answer is matched or none of the candidate answers are matched. In some embodiments, the fourth node may include, for example, a processing node of a suitable type as discussed above.

For example, the user may connect the input control 370-2 to any appropriate node supported in the workflow to indicate that the candidate answer 370-2 may trigger the node to perform a corresponding action. Taking FIG. 3D as an example, when the user clicks on the candidate answer 380-2 or inputs a response message indicating a selection of the candidate answer 380-2, the subsequent node may be triggered to be executed.

In this case, the target action required to be executed by the first node 315 based on the response content for the target question may trigger execution of the corresponding subsequent node based on the response content.

Based on the processes described above, the embodiments of the present disclosure may support creating a question-and-answer node so as to obtain a content of a variable according to a user input or adjust an execution logic of the workflow according to a user input during the execution.

At block 230, the electronic device 110 creates a target workflow based on the node connected graph.

With continued reference to FIG. 3A, in some embodiments, after completing the editing of the node connected graph, the electronic device 110 may trigger a corresponding debug process, e.g., based on a control 345. Additionally, the electronic device 110 may further create and release the corresponding target workflow based on a trigger on a control 350.

As an example, the electronic device 110 may create a corresponding target workflow based on configuration information for respective nodes in the node connected graph and the connections between the nodes, etc. The target workflow, for example, can be released or shared to other users.

In some embodiments, such a target workflow may be released independently. Alternatively, an application, e.g., a bot or an agent, based on the target workflow may be triggered to be created and/or released.

Based on the processes described above, the embodiments of the present disclosure can support adding a question-and-answer node so as to obtain a response content from users for a particular question and trigger a corresponding action to be executed during execution of the workflow.

### Example Apparatus and Devices

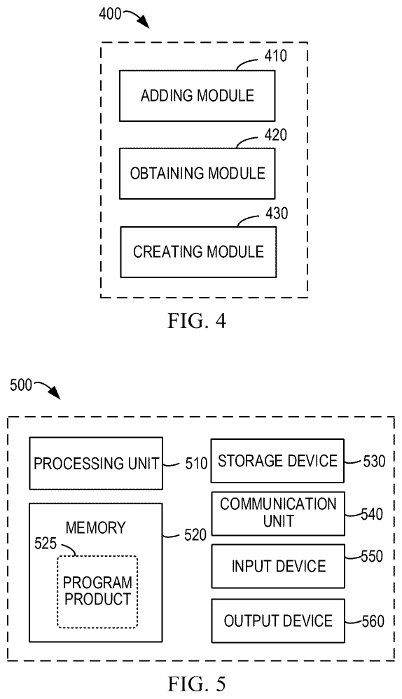

The embodiments of the present disclosure also provide a corresponding apparatus for implementing the above described methods or processes. FIG. 4 illustrates a schematic structural block diagram of an example apparatus 400 for workflow creation, according to certain embodiments of the present disclosure. The apparatus 400 may be implemented as or included in the electronic device 110. The various modules/components in the apparatus 400 may be implemented by hardware, software, firmware, or any combination thereof.

As shown in FIG. 4, the apparatus 400 includes: an adding module 410 configured to add, in response to a received operation associated with the creation or editing of a workflow, a first node associated with a question-and-answer interaction to a node connected graph; an obtaining module 420 configured to obtain configuration information for the first node via a set of input controls associated with the first node, the configuration information indicating: a target question to be provided in response to the first node being triggered, and a target action to be executed by the first node based on a response received for the target question; and a creating module 430 configured to create a target workflow based on the node connected graph.

In some embodiments, the adding module 410 is further configured to: present a plurality of interface elements corresponding to a plurality of node types; and in response to a selection of a target interface element from the plurality of interface elements, add the first node to the node connected graph, the target interface element corresponding to a question-and-answer node.

In some embodiments, the obtaining module 420 is further configured to: obtain question description text via a first input control in the set of input controls; and determine, based on the question description text, the target question to be provided in response to the first node being triggered.

In some embodiments, the question description text references a target data object in a second node associated with the first node.

In some embodiments, the obtaining module 420 is further configured to determine, in response to a second input control in the set of input controls indicating that the first node corresponds to a first question type, parameter description information via at least one third input control in the set of input controls, the parameter description information indicating at least one parameter to be determined based on the response.

In some embodiments, the apparatus 400 further includes a providing module configured to provide, during execution of the target workflow and in response to a parameter value of the at least one parameter being determined based on the response, the parameter value of the at least one parameter to a third node associated with the first node.

In some embodiments, the obtaining module 420 is further configured to determine, in response to a second input control in the set of input controls indicating that the first node corresponds to a second question type, a set of candidate answers to the target question via at least one fourth input control in the set of input controls.

In some embodiments, the configuration information further indicates a first action to be triggered for execution by a target candidate answer in the set of candidate answers, and/or a second action to be triggered for execution in response to none of the set of candidate answers being matched.

In some embodiments, the node connected graph includes a connection element between the target candidate answer and a fourth node, the connection element indicating that the target candidate answer triggers the fourth node to be executed.

In some embodiments, the apparatus 400 further includes a presenting module configured to present, during execution of the target workflow and in response to the first node being triggered, the target question and the set of candidate answers.

In some embodiments, the response content includes: a selection of at least one candidate answers in the set of candidate answers, or a response message input by the user.

FIG. 5 illustrates a block diagram of an electronic device 500 in which one or more embodiments of the present disclosure may be implemented. It should be appreciated that the electronic device 500 shown in FIG. 5 is merely exemplary and should not constitute any limitation on the functionality and scope of the embodiments described herein. The electronic device 500 shown in FIG. 5 may be configured to implement the electronic device 110 of FIG. 1.

As shown in FIG. 5, the electronic device 500 is in the form of a general-purpose electronic device. The components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and capable of performing various processes according to a program stored in the memory 520. In a multiprocessor system, a plurality of processing units execute computer-executable instructions in parallel to improve the parallel processing capabilities of electronic device 500.

The electronic device 500 typically includes a variety of computer storage media. Such media may be any available media that is accessible to the electronic device 500, including, but not limited to, volatile and non-volatile media, removable and non-removable media. The memory 520 may be a volatile memory (e.g., a register, cache, random access memory (RAM)), non-volatile memory (e.g., read-only memory (ROM), electrically erasable programmable read-only memory (EEPROM), flash memory), or some combination thereof. The storage device 530 may be a removable or non-removable medium and may include a machine-readable medium, such as a flash drive, magnetic disk, or any other medium that can be used to store information and/or data and that can be accessed within the electronic device 500.

The electronic device 500 may further include an additional removable/non-removable, volatile/non-volatile storage medium. Although not shown in FIG. 5, a disk drive for reading from or writing to a removable, non-volatile magnetic disk (e.g., a “floppy disk”) or an optical disk drive for reading from or writing to a removable, non-volatile optical disk may be provided. In these cases, each drive may be connected to a bus (not shown) by one or more data media interfaces. The memory 520 may include a computer program product 525 having one or more program modules configured to execute various methods or actions of the various embodiments of the present disclosure.

The communication unit 540 is configured to communicate with other electronic devices through a communication medium. Additionally, the functionality of components of the electronic device 500 may be implemented by a single computing cluster or multiple computing machines capable of communicating through a communication connection. Thus, the electronic device 500 may operate in a networked environment using a logical connection with one or more other servers, network personal computers (PCs), or another network node.

The input device 550 may be one or more input devices such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed. The external device, such as a storage device, a display device, etc., communicates with one or more devices that enable users to interact with the electronic device 500, or communicates with any device (e.g., a network card, a modem, etc.) that enables the electronic device 500 to communicate with one or more other electronic devices. Such communication may be performed via an input/output (I/O) interface (not shown).

According to example implementations of the present disclosure, a computer-readable storage medium having computer-executable instructions stored thereon is provided. The computer-executable instructions are executed by a processor to implement the method described above. According to example implementations of the present disclosure, a computer program product is further provided. The computer program product is tangibly stored on a non-transitory computer-readable medium and includes computer-executable instructions. The computer-executable instructions are executed by a processor to implement the method described above.

Various aspects of the present disclosure are described herein with reference to flowcharts and/or block diagrams of methods, apparatuses, devices, and computer program products implemented according to the present disclosure. It would be appreciated that each block of the flowchart and/or block diagram, and combinations of blocks in the flowcharts and/or block diagrams, may be implemented by computer readable program instructions.

These computer-readable program instructions may be provided to a processing unit of a general-purpose computer, special computer, or other programmable data processing apparatus to produce a machine that generates a device to implement the functions/acts specified in one or more blocks in the flow chart and/or the block diagram when these instructions are executed through the processing units of the computer or other programmable data processing devices. These computer-readable program instructions may also be stored in a computer-readable storage medium. These instructions cause the computer, programmable data processing apparatus, and/or other devices to work in a specific way. Therefore, the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other devices, such that a series of operational steps can be performed on a computer, other programmable data processing apparatus, or other devices to produce a computer-implemented process such that the instructions executed on a computer, other programmable data processing apparatus, or other apparatus implement the functions/acts specified in the flowchart and/or block diagram block or blocks.

The flowchart and block diagrams in the drawings show the possible architecture, functions and operations of the system, the method, and the computer program product implemented according to various implementations of the present disclosure. In this regard, each block in the flowchart or block diagram may represent a part of a module, a program segment or instructions, which contains one or more executable instructions for implementing the specified logic function. In some alternative implementations, the functions marked in the block may also occur in a different order from those marked in the drawings. For example, two consecutive blocks may be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Various implementations of the present disclosure have been described above. The above description is exemplary, not exhaustive, and the present application is not limited to the disclosed implementations. Without departing from the scope and spirit of the described implementations, many modifications and changes are obvious to those skilled in the art. The terminology used herein has been chosen to best explain the principles of the respective implementations, the practical applications or improvements to the technology in the marketplace, or to enable those skilled in the art to understand the implementations disclosed herein.

1. A method for workflow creation, comprising:
in response to a received operation, adding a first node associated with a question-and-answer interaction to a node connected graph;
obtaining configuration information for the first node via a set of input controls associated with the first node, the configuration information indicating: a target question to be provided in response to the first node being triggered, and a target action to be executed by the first node based on a response received for the target question; and
creating a target workflow based on the node connected graph.

2. The method of claim 1, wherein adding the first node associated with the question-and-answer interaction to the node connected graph in response to the received operation comprises:
presenting a plurality of interface elements corresponding to a plurality of node types; and
in response to a selection of a target interface element from the plurality of interface elements, adding the first node to the node connected graph, the target interface element corresponding to a question-and-answer node.

3. The method of claim 1, wherein obtaining the configuration information for the first node via the set of input controls associated with the first node comprises:
obtaining question description text via a first input control in the set of input controls; and
determining, based on the question description text, the target question to be provided in response to the first node being triggered.

4. The method of claim 3, wherein the question description text references a target data object in a second node associated with the first node.

5. The method of claim 1, wherein obtaining the configuration information for the first node via the set of input controls associated with the first node comprises:
in response to a second input control in the set of input controls indicating that the first node corresponds to a first question type, determining parameter description information via at least one third input control in the set of input controls, the parameter description information indicating at least one parameter to be determined based on the response.

6. The method of claim 5, further comprising:
during execution of the target workflow and in response to a parameter value of the at least one parameter being determined based on the response, providing the parameter value of the at least one parameter to a third node associated with the first node.

7. The method of claim 1, wherein obtaining the configuration information for the first node via the set of input controls associated with the first node comprises:
in response to a second input control in the set of input controls indicating that the first node corresponds to a second question type, determining a set of candidate answers to the target question via at least one fourth input control in the set of input controls.

8. The method of claim 7, wherein the configuration information further indicates:
a first action to be triggered for execution by a target candidate answer in the set of candidate answers, and/or
a second action to be triggered for execution in response to none of the set of candidate answers being matched.

9. The method of claim 8, wherein the node connected graph comprises a connection element between the target candidate answer and a fourth node, the connection element indicating that the target candidate answer triggers the fourth node to be executed.

10. The method of claim 7, further comprising:
during execution of the target workflow and in response to the first node being triggered, presenting the target question and the set of candidate answers.

11. The method of claim 10, wherein the response content comprises:
a selection of at least one candidate answers in the set of candidate answers, or
a response message input by the user.

12. An electronic device, comprising:
at least one processing unit; and
at least one memory, the at least one memory being coupled to the at least one processing unit and storing instructions for execution by the at least one processing unit, the instruction, when executed by the at least one processing unit, causing the electronic device to perform operations comprising:
in response to a received operation, adding a first node associated with a question-and-answer interaction to a node connected graph;
obtaining configuration information for the first node via a set of input controls associated with the first node, the configuration information indicating: a target question to be provided in response to the first node being triggered, and a target action to be executed by the first node based on a response received for the target question; and
creating a target workflow based on the node connected graph.

13. The electronic device of claim 12, wherein adding the first node associated with the question-and-answer interaction to the node connected graph in response to the received operation comprises:
presenting a plurality of interface elements corresponding to a plurality of node types; and
in response to a selection of a target interface element from the plurality of interface elements, adding the first node to the node connected graph, the target interface element corresponding to a question-and-answer node.

14. The electronic device of claim 12, wherein obtaining the configuration information for the first node via the set of input controls associated with the first node comprises:
obtaining question description text via a first input control in the set of input controls; and
determining, based on the question description text, the target question to be provided in response to the first node being triggered.

15. The electronic device of claim 14, wherein the question description text references a target data object in a second node associated with the first node.

16. The electronic device of claim 12, wherein obtaining the configuration information for the first node via the set of input controls associated with the first node comprises:
in response to a second input control in the set of input controls indicating that the first node corresponds to a first question type, determining parameter description information via at least one third input control in the set of input controls, the parameter description information indicating at least one parameter to be determined based on the response.

17. The electronic device of claim 16, wherein the operations further comprise:
during execution of the target workflow and in response to a parameter value of the at least one parameter being determined based on the response, providing the parameter value of the at least one parameter to a third node associated with the first node.

18. The electronic device of claim 12, wherein obtaining the configuration information for the first node via the set of input controls associated with the first node comprises:
in response to a second input control in the set of input controls indicating that the first node corresponds to a second question type, determining a set of candidate answers to the target question via at least one fourth input control in the set of input controls.

19. The electronic device of claim 18, wherein the configuration information further indicates:
a first action to be triggered for execution by a target candidate answer in the set of candidate answers, and/or
a second action to be triggered for execution in response to none of the set of candidate answers being matched.

20. A non-transitory computer readable storage medium having a computer program stored thereon, wherein the computer program is executable by a processor to implement a method comprising:
in response to a received operation, adding a first node associated with a question-and-answer interaction to a node connected graph;
obtaining configuration information for the first node via a set of input controls associated with the first node, the configuration information indicating: a target question to be provided in response to the first node being triggered, and a target action to be executed by the first node based on a response received for the target question; and
creating a target workflow based on the node connected graph.
